(19) United States
(12) Patent Application Publication
(10) Pub. No.: US 2017/0178153 A1
(43) Pub. Date: Jun. 22, 2017

(54) IMPULSE DETECTION AND MODELING METHOD AND APPARATUS

(71) Applicant: MASTERCARD INTERNATIONAL INCORPORATED, Purchase, NY (US)

(72) Inventors: Shen Xi MENG, Millwood, NY (US); Po HU, Norwalk, CT (US); Qian WANG, Ridgefield, CT (US)

(21) Appl. No.: 14/977,441

(22) Filed: Dec. 21, 2015

(51) Int. Cl. G06Q 30/02; G06N 99/00; G06N 7/00; H04L 29/08

(52) U.S. Cl. CPC G06Q 30/0201; H04L 67/12; G06N 99/005; G06N 7/005

(57) ABSTRACT

A system, method, and computer-readable storage medium configured to detect and model impulse behavior.

### BACKGROUND

Field of the Disclosure

Aspects of the disclosure relate in general to computer science. Aspects include an apparatus, system, method and computer-readable storage medium to detect and model impulse behavior.

Description of the Related Art

In the technical fields of computer analytics and operations research, pattern detection includes a number of methods for extracting meaning from large and complex data sets through a combination of operations research methods, graph theory, data analysis, clustering, and advanced mathematics.

Unlike machine learning, deep learning, or data mining, pattern detection is data agnostic, requiring only an ingestible data format to compute correlations in data.

Graph algorithms detect patterns of co-occurrence to create a holistic representation of connections a given set of data. Analysis has been applied to industries including transportation, manufacturing, and other fields, such as computer science.

Another different area of technology is computer modeling or computer simulation.

A computer simulation is a simulation, run on a single computer, or a network of computers, to reproduce behavior of a system. The simulation uses an abstract model (a computer model, or a computational model) to simulate the system. Computer simulations have become a useful part of mathematical modeling of many natural systems in physics (computational physics), astrophysics, climatology, chemistry and biology, human systems in economics, psychology, social science, and engineering. Simulation of a system is represented as the running of the system's model. It can be used to explore and gain new insights into new technology and to estimate the performance of systems too complex for analytical solutions.

Computer simulations vary from computer programs that run a few minutes to network-based groups of computers running for hours to ongoing simulations that run for days. The scale of events being simulated by computer simulations has far exceeded anything possible (or perhaps even imaginable) using traditional paper-and-pencil mathematical modeling. Over 10 years ago, a desert-battle simulation of one force invading another involved the modeling of 66,239 tanks, trucks and other vehicles on simulated terrain around Kuwait, using multiple supercomputers in the Department of Defense High Performance Computer Modernization Program. Other computer modeling examples include: a billion-atom model of material deformation, a 2.64-million-atom model of the complex maker of protein in all organisms called a “ribosome,” a complete simulation of the life cycle of mycoplasma genitalium, and the “Blue Brain” project at the École Polytechnique Fédérale de Lausanne (EPFL) in Switzerland to create the first computer simulation of the entire human brain, right down to the molecular level.

### SUMMARY

Embodiments include a system, apparatus, device, method and computer-readable medium configured to detect and model impulse behavior.

An apparatus embodiment comprises a network interface, a processor, and a non-transitory computer-readable storage medium. The network interface receives transaction data regarding a plurality of transactions associated with an individual. For each of the plurality of transactions, the transaction data comprises: a transaction identifier, an account identifier, a time and date of the transaction, a merchant identifier, and a transaction amount. The processor matches each of the plurality of transactions to a list of items purchased in each transaction in a purchase database. The matching uses the transaction identifier, the account identifier, the time and date of the transaction, the merchant identifier, and the transaction amount. The processor detects an impulse purchase based on the account identifier, the time and date of the transaction, the merchant identifier, the transaction amount and list of items purchased, resulting in a detected impulse purchase. The processor summarizes the detected impulse purchase using independent variables, resulting in summarized detected impulse purchases. The independent variables include: time duration, frequency, channel, and the transaction amount. The summarized detected impulse purchases are machine learning data mined with the independent variables and feedback from an individual impulse prediction model. The processor models the machine learning data mined summarized detected impulse purchases to refine the individual impulse prediction model and to generate an individual impulse assessment associated with the account identifier. The individual impulse prediction model and the individual impulse assessment are stored to a non-transitory computer-readable storage medium. The network interface transmits the individual impulse assessment to a merchant, issuer, or acquirer.

### BRIEF DESCRIPTION OF THE DRAWINGS

FIG. 1 depicts a data flow diagram of an impulse detection and modeling method embodiment.

FIG. 2 illustrates an embodiment of a system configured to detect and model impulse behavior.

### DETAILED DESCRIPTION

One aspect of the disclosure includes the realization that consumer purchase behavior is a powerful source of information that complements demographics and self-reported preferences to create a complete profile of an individual's behavior.

Another aspect of the disclosure includes the understanding that analyzing cardholder spending provides a source of predictive information that may be used to assess impulsive behavior. The use of payment cards, such as credit or debit cards, is ubiquitous in commerce. Typically, a payment card is electronically linked with a payment network to an account or accounts belonging to a cardholder. These accounts are generally deposit accounts, loan or credit accounts at an issuer financial institution. During a purchase transaction, the cardholder can present the payment card in lieu of cash or other forms of payment.

Payment networks process billions of purchase transactions by cardholders. The data from the purchase transactions can be used to analyze cardholder behavior. Typically, the transaction level data can be used only after it is summarized up to customer level. Unfortunately, the current transaction rolled-up processes are pre-knowledge based and do not result in transaction level models.

A cardholder may indicate propensity for impulsive behavior, which can be simulated with a computer. An impulse purchase, also referred to as “impulse buying,” is an unplanned decision to buy a product or service, made just before a purchase. These cardholders are not buying items according to their cognitive planning, but according to their emotional impulse. A shopper that tends to make such purchases is referred to as an “impulse purchaser” or “impulse buyer.”

Marketers and retailers tend to exploit by whom, where, and when these impulses purchase behaviors can occur; and credit card risk managers are interested in what triggers an emotional shopping addiction.

Although consumer research and psychological literatures provide some theoretical insights of this purchase behavior, there is no appropriate methodology to identify the impulse buyers and to describe their behavior patterns in the actual business world. An aspect of the disclosure is that such impulsive behavior may be reflected in the cardholder's purchase behavior. For example, a “last minute” purchase is a known impulsive behavior; a cardholder that purchases an unusual item that is not part of a typical purchase. These and other similar cardholder purchases and expenditures may contain predictive information for the development of an individual impulse prediction model.

Yet another aspect of the disclosure is the realization that an individual impulse prediction model may be applied to the tolerance of impulse for investment purposes.

Embodiments of the present disclosure include a system, method, and computer-readable storage medium configured to enable individual impulse detection and prediction modeling of individuals based on their payment card purchases. For the purposes of this disclosure, a payment card includes, but is not limited to: credit cards, debit cards, prepaid cards, electronic checking, electronic wallet, or mobile device payments.

Embodiments solve a technical problem of being able to efficiently identify impulse purchasers and explore their behavior patterns by utilizing and analyzing consumer transaction data. Furthermore, based on consumer transaction data, embodiments can predict the prospective cardholders that will likely be impulse buyers; and by using other information (e.g., demographic or attitudinal information), an embodiment may identify internal and external factors that trigger impulse purchases.

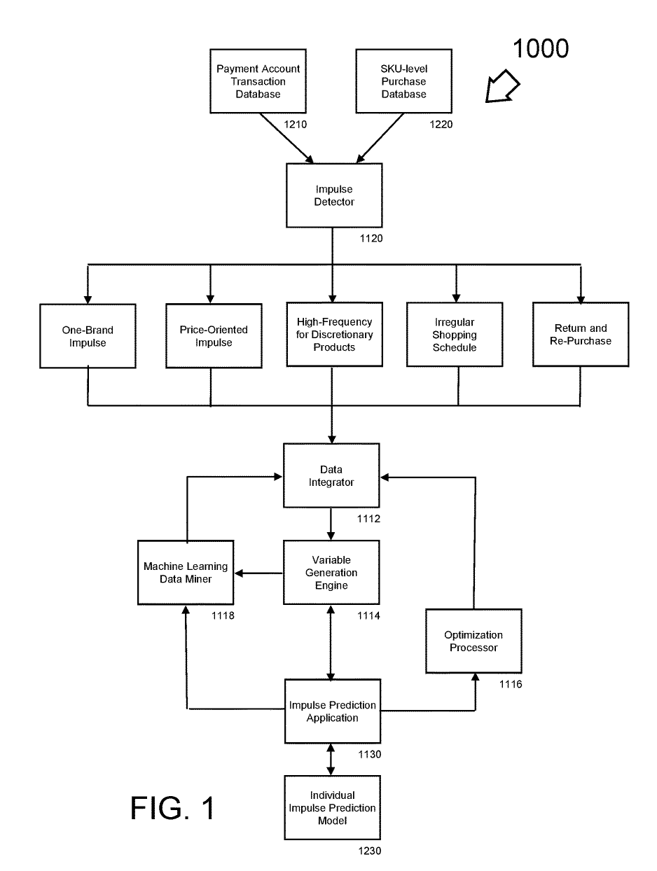

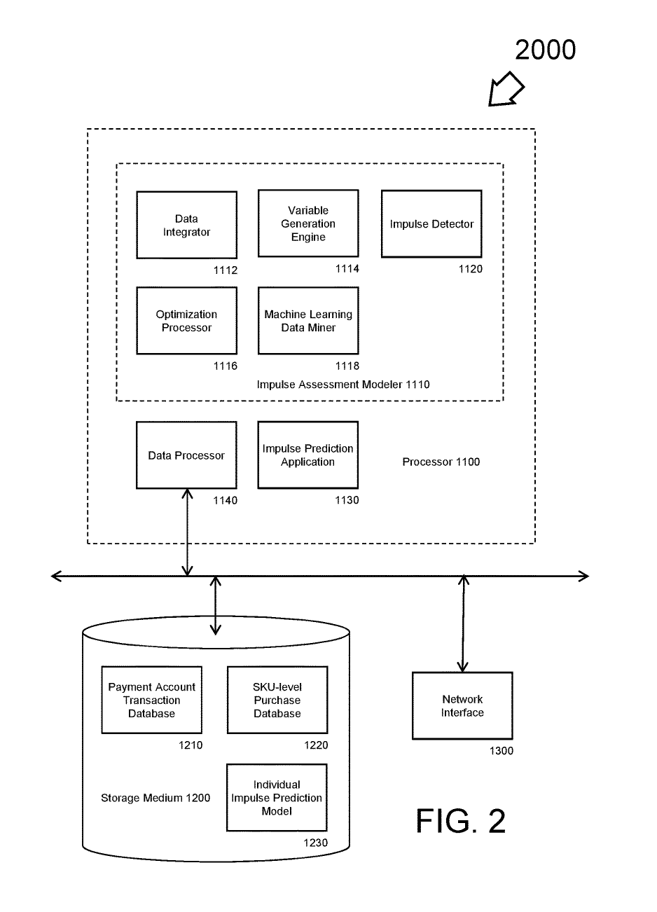

Embodiments will now be disclosed concurrently with reference to a block diagram of a data flow diagram of an impulse detection and modeling method 1000 of FIG. 1, being executed by an exemplary impulse assessment apparatus server 2000 configured to detect and model impulse behavior of FIG. 2, constructed and operative in accordance with an embodiment of the present disclosure.

Impulse assessment apparatus 2000 may run a multi-tasking operating system (OS) and include at least one processor or central processing unit (CPU) 1100, a non-transitory computer-readable storage medium 1200, and a network interface 1300. An example operating system may include Advanced Interactive Executive (AIXTM) operating system, UNIX operating system, or LINUX operating system, and the like.

Processor 1100 may be a central processing unit (CPU), microprocessor, micro-controller, computational device or circuit known in the art. In some embodiments, apparatus 2000 may have one or more processors 1100. It is understood that processor 1100 may communicate with and temporarily store information in Random Access Memory (RAM) (not shown).

As shown in FIG. 2, processor 1100 is functionally comprised of an impulse assessment modeler 1110, an impulse prediction application 1130, and a data processor 1140.

Impulse assessment modeler 1110 is a component configured to detect and perform impulse estimation by analyzing cardholder transactions. Impulse assessment modeler 1110 may further comprise: a data integrator 1112, variable generation engine 1114, optimization processor 1116, machine learning data miner 1118, and an impulse detector 1120.

Data integrator 1112 is an application program interface (API) or any structure that enables the impulse assessment modeler 1110 to communicate with, or extract data from, a database.

Variable generation engine 1114 is any structure or component capable of generating customer level target-specific variable layers from given transaction level data.

Optimization processor 1116 is any structure configured to receive target variables from a transaction level model defined from a business application and refine the target variables.

Machine learning data miner 1118 is a structure that allows users of the impulse assessment modeler 1110 to enter, test, and adjust different parameters and control the machine learning speed. In some embodiments, machine learning data miner uses decision tree learning, association rule learning, neural networks, inductive logic programming, support vector machines, clustering, Bayesian networks, reinforcement learning, representation learning, similarity and metric learning, spare dictionary learning, and ensemble methods such as random forest, boosting, bagging, and rule ensembles, or a combination thereof.

Impulse detector 1120 is any structure configured to detect an impulsive transaction. Impulse detector 1120 applies a base line to define the impulse behavior in purchase frequency, ticket size, industry category, geo-location from transaction data.

Impulse prediction application 1130 is an application that utilizes impulse information produced by impulse assessment modeler 1110 to create an individual impulse prediction model 1230. In some embodiments, a feedback mechanism allows impulse prediction application 1130 to receive input from individual impulse prediction model 1230 and impulse assessment modeler 1110 to refine the individual impulse prediction model 1230.

Data processor 1140 enables processor 1100 to interface with storage medium 1200, network interface 1300 or any other component not on the processor 1100. The data processor 1140 enables processor 1100 to locate data on, read data from, and write data to these components.

These structures may be implemented as hardware, firmware, or software encoded on a computer readable medium, such as storage medium 1200. Further details of these components are described with their relation to method embodiments below.

Network interface 1300 may be any data port as is known in the art for interfacing, communicating or transferring data across a computer network, examples of such networks include Transmission Control Protocol/Internet Protocol (TCP/IP), Ethernet, Fiber Distributed Data Interface (FDDI), token bus, or token ring networks. Network interface 1300 allows impulse assessment apparatus server 1000 to communicate with vendors, cardholders, issuer and acquirer financial institutions.

Computer-readable storage medium 1200 may be a conventional read/write memory such as a magnetic disk drive, floppy disk drive, optical drive, compact-disk read-only-memory (CD-ROM) drive, digital versatile disk (DVD) drive, high definition digital versatile disk (HD-DVD) drive, Blu-ray disc drive, magneto-optical drive, optical drive, flash memory, memory stick, transistor-based memory, magnetic tape or other computer-readable memory device as is known in the art for storing and retrieving data. Significantly, computer-readable storage medium 1200 may be remotely located from processor 1100, and be connected to processor 1100 with a network such as a local area network (LAN), a wide area network (WAN), or the Internet.

In addition, as shown in FIG. 2, storage medium 1200 may also contain a payment account transaction database 1210, Stock Keeping Unit (SKU)-level purchase database 1220, and an individual impulse prediction model 1230. Payment account transaction database 1210 is configured to store records of payment card transactions. SKU-level purchase database 1220 is configured to store stock keeping unit level purchase information from merchant transactions; in some embodiments, the SKU-level purchase database 1220 may contain a plurality of transactions with SKU-level information about every item purchased in each purchase transaction. A Stock Keeping Unit is a unique identifier for each distinct product and service that can be purchased in business. It is understood that some embodiments may use other identifiers, such as the Universal Product Code (UPC), International Article Number (EAN), Global Trade Item Number (GTIN), or Australian Product Number (APN). An individual impulse prediction model 1230 is an impulse model for a cardholder based on cardholder transactions. In some embodiments, an initial impulse model based on an average cardholder may be used initially for an individual cardholder's impulse prediction model 1230, to be refined by the individual cardholder's purchase transactions.

It is understood by those familiar with the art that one or more of these databases 1210-1230 may be combined in a myriad of combinations. The function of these structures may best be understood with respect to the data flow diagram of FIG. 1, as described below.

We now turn our attention to the method or process embodiments of the present disclosure described in the data flow diagram of FIG. 1. It is understood by those known in the art that instructions for such method embodiments may be stored on their respective computer-readable memory and executed by their respective processors.

FIG. 1 is a data flow diagram of an impulse assessment method 1000 to enable individual impulse detection and prediction modeling of individuals based on their payment card purchases, constructed and operative in accordance with an embodiment of the present disclosure. The resulting individual impulse prediction model 1230 may be used in impulse assessment to determine customer impulse likelihood for a variety of impulse prediction application 1130 categories described below. Method 1000 is systematic data driven approach of detecting impulsive event by product, brand name, price, and so on by purchase transaction data. Additionally, with detected impulsive targets from purchase transaction data and SKU level data, method 1000 uses data mining and machine learning procedures to predict future impulsive events.

As shown in FIG. 1, impulse detector 1120 receives input from payment account transaction database 1210 and SKU-level purchase database 1220. For each individual cardholder analyzed, the impulse detector 1120 receives the individual cardholder's transaction data from the payment account transaction database 1210. For each transaction, the individual transaction data includes: a transaction identifier, an account identifier (usually a Primary Account Number or “PAN”), a time and date of the transaction, the merchant location or venue for the transaction (specified by a merchant identifier), and the amount of the transaction. Each transaction may then be cross-referenced with merchant information provided by SKU-level purchase database 1220, which contains transaction information at a merchant level. For each transaction at the merchant, the merchant transaction data includes: a transaction identifier, an account identifier (which may be the Primary Account Number), a time and date of the transaction, the merchant location or venue for the transaction (specified by the merchant identifier), the amount of the transaction and a list of items purchased identified by SKU. The cross-referencing between the transaction identifier, the account identifier, the time and date of the transaction, the merchant identifier, and/or the transaction amount the allows impulse detector 1120 to find the transaction within the SKU-level purchase database 1220, and determine the individual items (identified by the SKU) purchased with each transaction.

From the cross-referenced data, impulse detector 1120 may detect a variety of different forms of impulsive purchase behavior. These impulsive purchase behaviors may include one or more of the following behaviors: one-brand impulse, price-oriented impulse, high-frequency for discretionary products or discretionary merchants, irregular shopping schedule, and return-and-re-purchase behaviors.

One-brand impulse is the tendency to purchase different products with the same brand. Products with the same brand are determined by the SKU of the purchases. In some embodiments, impulse detector 1120 detects a one-brand impulse based on the number of purchases of a single brand's products within a monthly billing cycle, or several monthly billing cycles. When the number of purchases exceeds a predetermined number, then the impulse detector 1120 determines that a one-brand impulse is exhibited. For example, suppose a cardholder purchases eight Acme products in a single monthly billing cycle, and also suppose that the predetermined number of purchases is five. In such an example, impulse detector 1120 determines that the one-brand impulse is exhibited by the cardholder. In an alternate embodiment, impulse detector 1120 detects a one-brand impulse based a cardholder's one-brand purchase deviation from the average person's one-brand purchases. In such an embodiment, impulse detector 1120 calculates the number of times products from a brand is purchased for each cardholder. An average number of times is calculated from the universe of cardholders or a subset of the universe of cardholders to determine the behavior of an average cardholder. If a particular cardholder's number of purchases from a single brand exceeds the average cardholder's purchases from the single brand by one standard deviation, impulse detector 1120 determines that the particular cardholder exhibits a one-brand impulse behavior.

Pricing-oriented impulse is the likelihood of purchasing items with high-end or low-end prices. Impulse detector 1120 detects a pricing-oriented impulse based a cardholder's pricing-oriented purchase deviation from the average person's purchases. In such an embodiment, impulse detector 1120 calculates the cost of particular products (based on the SKU) purchased for each cardholder. An average cost for the particular products is calculated. If a particular cardholder's cost of purchases from the particular products deviates from the average cardholder's purchases by 1, 1.5, or 2 standard deviations (either high or low), impulse detector 1120 determines that the particular cardholder exhibits a pricing-oriented impulse behavior. Repeated purchases in which the cost exceeds the average purchase price by a standard deviation is considered an indication of high price-oriented impulse behavior. Conversely, repeated purchases in which the cost is under the average purchase price by a standard deviation is considered an indication of low price-oriented impulse behavior.

High-frequency for discretionary products or discretionary merchants is the likelihood of purchasing non-essential products or from merchants that sell non-essential goods or services. Products are determined by the SKU of the purchases. Merchants may be determined by a merchant identifier. In some embodiments, impulse detector 1120 detects a discretionary products or merchants impulse based on the number of purchases of a discretionary product or at a discretionary merchant within a monthly billing cycle, or several monthly billing cycles. When the number of purchases exceeds a predetermined number, then the impulse detector 1120 determines that a discretionary product or discretionary merchant impulse is exhibited. In an alternate embodiment, impulse detector 1120 detects a discretionary impulse based a cardholder's discretionary purchase deviation from the average person's discretionary purchases. In such an embodiment, impulse detector 1120 calculates the number of times discretionary products are purchased for each cardholder. An average number of times is calculated from the universe of cardholders or a subset of the universe of cardholders to determine the behavior of an average cardholder. If a particular cardholder's number of purchases from a discretionary product or discretionary merchant exceeds the average cardholder's purchases by 1, 1.5, or 2 standard deviations, impulse detector 1120 determines that the particular cardholder exhibits a discretionary product or discretionary merchant impulse behavior.

Irregular shopping schedules may be determined by examining the whether the cardholder makes purchases with consistent transaction patterns. The number of times a cardholder frequents a particular merchant is calculated across an extended period of time, such as a year. For example impulse detector 1120 may determine that a cardholder shops at Acme grocery store six times a month in the past year. When the most recent month (or other period of time) deviates from the cardholder's typical shopping patterns, the impulse detector 1120 determines that an irregular shopping schedule may have occurred. In another embodiment, a comparison with other consumer's shopping patterns are made; when a cardholder changes their shopping patterns more frequently and irregularly than others, the cardholder may be defined as an irregular shopper.

Return and re-purchase behaviors are the likelihood of a cardholder to return purchased items and re-purchase items. Impulse detector 1120 identifies a return and re-purchase event when a cardholder returns a purchased item, and re-purchases the item within a short period of time, usually 2-3 days. Impulse detector 1120 identifies all the return and re-purchase events by a cardholder within the past year, and compares this behavior with other cardholders. When a particular cardholder's number of return and re-purchase exceeds the average cardholder's return and re-purchase behavior by 1, 1.5, or 2 standard deviations, impulse detector 1120 determines that the particular cardholder exhibits a return and re-purchase impulse behavior.

Impulse detector 1120 sorts the transactions into the categories of impulsive purchase behavior, and provides the resulting detected impulse purchase data to data integrator 1112.

Data integrator 1112 receives the detected impulse purchase data from the impulse detector 1120, and stores the detected impulse purchase data in the payment account transaction database 121, integrating the data in the cardholder's record. Data integrator 1112 also provides the data to the variable generation engine 1114.

Variable generation engine 1114 produces a variable layer with transaction attribute variables to support the impulse analysis. The variable generation engine 1114 may use independent variables to form a base line to define the impulse behavior. Independent variables may include, but are not limited to: purchase frequency, ticket size, industry category, geo-location from the data. The following example illustrates how the variable generation engine 1114 works on merchant-level data. The same approach can be used for product-level (SKU level) data.

TABLE 1
Sample Merchant-Level Data

| Account | Trans | | | Store | | Trans- | |
|---|---|---|---|---|---|---|---|
| ID | ID | Trans -Date | Trans_Time | Loc ID | Channel | Type | Amount |
| 1 | 1 | Dec. 1, 2013 | 6:08:10 PM | 1 | B | Payment | $68.64 |
| 1 | 2 | Dec. 8, 2013 | 6:49:52 PM | 1 | B | Payment | $52.25 |
| 1 | 3 | Dec. 15, 2013 | 5:50:29 PM | 1 | B | Payment | $63.46 |
| 1 | 4 | Dec. 22, 2013 | 7:29:28 PM | 1 | B | Payment | $52.43 |
| 1 | 5 | Dec. 29, 2013 | 5:52:58 PM | 1 | B | Payment | $55.74 |
| 1 | 6 | Jan. 5, 2014 | 7:00:59 PM | 1 | B | Payment | $55.44 |
| 1 | 7 | Jan. 12, 2014 | 6:26:36 PM | 1 | B | Payment | $61.18 |
| 2 | 1 | Dec. 1, 2013 | 7:18:22 PM | 8 | B | Payment | $65.62 |
| 2 | 2 | Dec. 8, 2013 | 8:22:00 AM | 6 | B | Payment | $104.50 |
| 2 | 3 | Dec. 17, 2013 | 10:59:40 AM | 6 | B | Payment | $139.90 |
| 2 | 4 | Dec. 23, 2013 | 11:25:12 AM | 7 | B | Payment | $170.63 |
| 2 | 5 | Dec. 26, 2013 | 1:46:28 AM | 8 | B | Payment | $29.71 |
| 2 | 6 | Jan. 3, 2014 | 12:43:20 PM | 7 | B | Payment | $75.17 |
| 2 | 6 | Jan. 8, 2014 | 6:09:49 PM | 9 | B | Payment | $78.65 |
| 2 | 6 | Jan. 20, 2014 | 4:53:04 PM | 10 | B | Payment | $146.38 |
| 2 | 6 | Jan. 26, 2014 | 7:36:32 PM | 3 | B | Payment | $66.02 |
| 2 | 6 | Feb. 5, 2014 | 2:32:12 AM | 2 | O | Payment | $159.52 |
| 2 | 6 | Feb. 18, 2014 | 10:43:30 AM | 8 | B | Payment | $102.12 |
| 2 | 6 | Feb. 25, 2014 | 4:32:39 PM | 8 | B | Payment | $42.04 |
| 2 | 6 | Mar. 9, 2014 | 4:40:48 AM | 3 | B | Payment | $36.16 |
| 2 | 6 | Mar. 23, 2014 | 9:49:41 AM | 4 | B | Payment | $124.55 |

The variable generation engine 1114 summarizes transactions and creates cardholder account-level variables. It can summarize many variables based on time duration, frequency, channel, amount by each merchant or merchant groups, or any other independent variable. As shown in Table 1 above, customer 1 (with ID=1) only used their payment card account at one merchant on Sundays and around 5 PM to 7 PM. The purchase amount is also similar in the range of $50 to $70. The consumer pattern is very clear. Customer 2, with ID=2, shopped in a more random pattern across multiple merchants, different dates and times, and different channels. The amount spent is also very different. For example, suppose a snapshot is taken at the end of 2013. Transaction frequency over last month can be determined at each merchant. For customer 1, the number of transactions at merchant 1 (shown by Merchant Location=1) is five, and for all other merchants is zero. For customer 2, the number of transactions for merchants 1 or 5 is zero, but the number transactions for other merchants is greater than zero. There are many options to summarize different variables based transaction frequency, amount, channel, and time interval by merchant or merchant group. The variable generation engine 1114 maximally uses the transaction information and generate as many variables as possible that are useful and related to future behavior patterns. Statistical techniques are used to derive impulse insights, based on the independent transaction attribute variables. The correlations are measured in a simulated environment. Variable generation engine 1114 selects a specific past date as a “snapshot” date. Transaction information before the snapshot date is used to predict the target event measured in an interval time post to the snapshot date. The correlation of past information to future target event can be measured for each variable. By this, variable generation engine 1114 assumes the past correlation between post and past respect to a snapshot date will hold up for the impulse prediction application 1130, where only past transactions are known. Statistical techniques are used to detect the correlation between variables and the future behavior patterns. Then the variables, which have high correlation with the target, will be selected as the candidates of predictors for the future modeling.

The selection of the independent variables summarized by the variable generation engine 1114 is not random. The impulse prediction application 1130 selects the relevant depending upon the prediction target. In order to know which impulsive events and impulsive intensity are to be measured, the impulse prediction 1130 defines the impulsive domain relevant to the impulsive events and intensities. For example, if the pricing for clothing is the subject, product SKU level details and dates are required. Specifically, in such an application, relevant independent variables would include: specific time durations, clothing product purchased, whether there were price incentives (sales or other discounts), and the brand of clothing purchased. If the customer has never purchased a specific brand, this effect can be excluded. If the price for the product sold is much cheaper than other customer purchased items in the same category, the variable generation engine 1114 can classify that the price is the reason for the customer to purchase more for this kind product. An expense ratio may be used as a factor to determine the price-oriented impulse.

The machine learning data miner 1118 uses proxies and modeling approaches to determine the likelihood of impulsive behaviors. In this processing, selected variables will be tested their effects on the target through multiple statistical techniques, and then some low effective variables will be excluded from the model. The procedure will be automatically repeated until some statistical criterions are satisfied and optimized modeling approach has been finalized. Once generated, the transaction attribute of interest is provided to the impulse prediction application 1130 and the machine learning data miner 1118. The machine learning data miner 1118 receives inputs from both the variable generation engine 1114 and the impulse prediction application 1130 to refine the individual impulse prediction model 1230. Machine learning data miner 1118 starts with dozens of attributes of the transaction data, and computes the implicit relationships of these attributes and the relationship of the attributes to the impulse prediction application 1130. The machine learning data miner 1118 derives from or transforms these attributes to their most useful form, then selects the variables for the variable generation engine 1114.

From vast transaction accounts and transaction times, nature of the transaction merchant, purchase amounts, and list of purchased items, the machine learning data miner can define two extreme groups of accounts. One group may have consistent transaction patterns and only shops in daily product stores like gas stations, grocery stores, and the like, unless the cardholders are traveling. The second group, of the impulse customers, may have inconsistent transaction patterns, with a high frequency of purchases at discretionary stores in their home shopping area. Most accounts are somewhere in between these two groups. Using a modeling approach to map the two extremes, the optimization processor 1116 can create a rank score or index for a group of cardholders to represent their impulsive intensity. The ranking is based on a probability or propensity score which is a relative index to predict the likelihood of a cardholder as an impulsive shopper.

Impulse prediction application 1130 also feeds information to optimization processor 1116. In essence, the optimization processor 1116 learns from vast transactional data, explores target relevant data dimensions, and generates optimal customer level variable summarization rules automatically. The optimization processor 1116 is similar to the machine learning data miner 1118, but the difference is that optimization processor 1116 is working on the data that has been aggregated to the account level. The final individual impulse prediction model 1230 is implemented on each account for actions to be taken upon. In some embodiments, the optimization processor 1116 and the machine learning data miner 1118 may be integrated into the same structure.

The optimization processor 1116 starts with selected variables (attributes) of each account (customer) and applies the statistical analysis to reduce the list of variables that appear to be related to impulsive behavior based on the customer's transaction data. The optimization may be accomplished by computing the relationship of these variables to the impulse prediction application 1130, and derives from or transforms these variables to their most useful form, applying the analytic phase to a broad universe of cardholders.

The impulse prediction application 1130, using the individual impulse prediction model 1230, may then transmit or display an individual impulse assessment for a cardholder based on their individual impulse prediction model 1230. The individual impulse assessment for the cardholder compares the cardholder to other cardholders, and may be associated with the cardholder's account identifier. The individual impulse assessment may be a numeric score, a series of numeric scores, or other indicators of whether the cardholder has impulsive behavior. When the individual impulse assessment of the cardholder is a series of numeric scores, the series of numeric scores may indicate the likelihood or tendency of the cardholder to make impulsive purchases based on one or more impulsive categories described above.

In some embodiments, the individual impulse assessment is a predictive index to forecast the likelihood of different kind of impulse purchase behavior for each consumer to find the impulse buyers in different impulse purchase preferences.

The individual impulse assessment may be stored in the payment account transaction database 1210 as part of the cardholder record or as part of the individual impulse prediction model 1230. In some embodiments, the individual impulse assessment is transmitted as part of a message to a merchant, issuer financial institution, or acquirer financial institution. In some embodiments, merchant, issuer, or acquirer may send a message to the individual cardholder based on their individual impulse prediction model 1230. In such an embodiment, the message sent may be a targeted advertisement based on the type of impulse behavior determined by the individual impulse prediction model 1230.

The feedback from optimization processor 1116 and machine learning data miner 1118 provide a machine learning approach for applying transactional data to customer impulse optimization problems.

The previous description of the embodiments is provided to enable any person skilled in the art to practice the disclosure. The various modifications to these embodiments will be readily apparent to those skilled in the art, and the generic principles defined herein may be applied to other embodiments. Thus, the present disclosure is not intended to be limited to the embodiments shown herein, but is to be accorded the widest scope consistent with the principles and novel features disclosed herein.

What is claimed is:

1. An impulse assessment and modeling method comprising:
receiving transaction data regarding a plurality of transactions associated with an individual with a network interface, for each of the plurality of transactions the transaction data comprising: a transaction identifier, an account identifier, a time and date of the transaction, a merchant identifier, and a transaction amount;
matching, with the processor, each of the plurality of transactions to a list of items purchased in each transaction in a purchase database, the matching performed using at least one of the transaction identifier, the account identifier, the time and date of the transaction, the merchant identifier, and the transaction amount;
detecting, with the processor, an impulse purchase based on the account identifier, the time and date of the transaction, the merchant identifier, the transaction amount and list of items purchased, resulting in a detected impulse purchase;
summarizing, with the processor, the detected impulse purchase using independent variables resulting in summarized detected impulse purchases, the independent variables including: time duration, frequency, channel, and the transaction amount;
modeling, with the processor, the summarized detected impulse purchases to create an individual impulse prediction model and to generate an individual impulse assessment associated with the account identifier using the individual impulse prediction model;
storing the individual impulse prediction model and the individual impulse assessment to a non-transitory computer-readable storage medium;
transmitting, with the network interface, the individual impulse assessment to a merchant, issuer, or acquirer.

2. The impulse assessment method of claim 1,
wherein modeling includes:
machine learning data mining the summarized detected impulse purchases with the independent variables and feedback from the individual impulse prediction model; and
modeling, with the processor, the machine learning data mined summarized detected impulse purchases to refine the individual impulse prediction model.

3. The impulse assessment method of claim 1,
wherein the impulse purchase is a one-brand impulse;
wherein the one-brand impulse is detected for each account identifier by:
determining, with the processor, a brand of each of the items in the list of items purchased;
determining, with the processor, a number of purchases of the brand for each account identifier within a period of time;
determining, with the processor, a number of purchases of the brand by an average account identifier within the period of time;
determining, with the processor, the one-brand impulse exists when the number of purchases of the brand for the account identifier exceeds one standard deviation from the number of purchases of the brand by an average account identifier.

4. The impulse assessment method of claim 1,
wherein the impulse purchase is a price-oriented impulse;
wherein the price-oriented impulse is detected for each account identifier by:
determining, with the processor, an average price of each of the items in the list of items purchased for each account identifier within a period of time;
determining, with the processor, an average price of each of the items in the list of items purchased for all account identifiers within the period of time;
determining, with the processor, the price-oriented impulse exists when the average price of each of the items in the list of items purchased for the account identifier deviates one standard deviation from the average price of each of the items in the list of items purchased for all account identifiers.

5. The impulse assessment method of claim 1,
wherein the impulse purchase is a high-frequency for discretionary products impulse;
wherein the high-frequency for discretionary products impulse is detected for each account identifier by:
determining, with the processor, a frequency of discretionary products in the list of items purchased for the account identifier within a period of time;
determining, with the processor, an average frequency of discretionary products in the list of items purchased for all the account identifiers within the period of time;
determining, with the processor, the high-frequency for discretionary products impulse exists when the frequency of discretionary products in the list of items purchased for the account identifier within the period of time deviates one standard deviation from the average frequency of discretionary products in the list of items purchased for all the account identifiers within the period of time.

6. The impulse assessment method of claim 1,
wherein the impulse purchase is a high-frequency for discretionary merchants impulse;
wherein the high-frequency for discretionary merchants impulse is detected for each account identifier by:
determining, with the processor, a frequency of purchases at discretionary merchants for the account identifier within a period of time;
determining, with the processor, an average frequency of purchases at discretionary merchants for all the account identifiers within the period of time;
determining, with the processor, the high-frequency for discretionary merchants impulse exists when the frequency of purchases at discretionary merchants for the account identifier within the period of time deviates one standard deviation from the average frequency of purchases at discretionary merchants for all the account identifiers within the period of time.

7. The impulse assessment method of claim 1,
wherein the impulse purchase is an irregular shopping schedule impulse;
wherein the irregular shopping schedule impulse is detected for each account identifier by:
determining, with the processor, a frequency of purchases at a merchant for the account identifier within a year;
determining, with the processor, a frequency of purchases at a merchant for the account identifier within a month;
determining, with the processor, the irregular shopping schedule impulse exists when the frequency of purchases at a merchant for the account identifier within the month deviates one standard deviation from the average frequency of purchases at a merchant for the account identifier within the year.

8. The impulse assessment method of claim 1,
wherein the impulse purchase is a return and repurchase impulse;
wherein the return and re-purchase impulse is detected for each account identifier by:
determining, with the processor, a frequency of return and repurchases for the account identifier within a period of time;
determining, with the processor, an average frequency of return and repurchases for all account identifiers within the period of time;
determining, with the processor, the return and re-purchase impulse exists when the frequency of return and repurchases for the account identifier deviates one standard deviation from the average frequency of return and repurchases for all account identifiers.

9. An impulse assessment apparatus comprising:
a network interface configured to receive transaction data regarding a plurality of transactions associated with an individual with a network interface, for each of the plurality of transactions the transaction data comprising: a transaction identifier, an account identifier, a time and date of the transaction, a merchant identifier, and a transaction amount;
a processor configured to match each of the plurality of transactions to a list of items purchased in each transaction in a purchase database, the matching performed using at least one of the transaction identifier, the account identifier, the time and date of the transaction, the merchant identifier, and the transaction amount, to detect an impulse purchase based on the account identifier, the time and date of the transaction, the merchant identifier, the transaction amount and list of items purchased, resulting in a detected impulse purchase, to summarize the detected impulse purchase using independent variables resulting in summarized detected impulse purchases, the independent variables including: time duration, frequency, channel, and the transaction amount, to model the machine learning data mined summarized detected impulse purchases to create an individual impulse prediction model and to generate an individual impulse assessment associated with the account identifier using the individual impulse prediction model;
a non-transitory computer-readable storage medium configured to store the individual impulse prediction model and the individual impulse assessment; and
the network interface is further configured to transmit the individual impulse assessment to a merchant, issuer, or acquirer.

10. The impulse assessment apparatus of claim 8,
wherein the processor is further configured to:
to machine learning data mine the summarized detected impulse purchases with the independent variables and feedback from the individual impulse prediction model; and
to model the machine learning data mined summarized detected impulse purchases to refine the individual impulse prediction model.

11. The impulse assessment apparatus of claim 9,
wherein the impulse purchase is a one-brand impulse;
wherein the one-brand impulse is detected for each account identifier by:
determining, with the processor, a brand of each of the items in the list of items purchased;
determining, with the processor, a number of purchases of the brand for each account identifier within a period of time;
determining, with the processor, a number of purchases of the brand by an average account identifier within the period of time;
determining, with the processor, the one-brand impulse exists when the number of purchases of the brand for the account identifier exceeds one standard deviation from the number of purchases of the brand by an average account identifier.

12. The impulse assessment apparatus of claim 9,
wherein the impulse purchase is a price-oriented impulse;
wherein the price-oriented impulse is detected for each account identifier by:
determining, with the processor, an average price of each of the items in the list of items purchased for each account identifier within a period of time;
determining, with the processor, an average price of each of the items in the list of items purchased for all account identifiers within the period of time;
determining, with the processor, the price-oriented impulse exists when the average price of each of the items in the list of items purchased for the account identifier deviates one standard deviation from the average price of each of the items in the list of items purchased for all account identifiers.

13. The impulse assessment apparatus of claim 9,
wherein the impulse purchase is a high-frequency for discretionary products impulse;
wherein the high-frequency for discretionary products impulse is detected for each account identifier by:
determining, with the processor, a frequency of discretionary products in the list of items purchased for the account identifier within a period of time;
determining, with the processor, an average frequency of discretionary products in the list of items purchased for all the account identifiers within the period of time;
determining, with the processor, the high-frequency for discretionary products impulse exists when the frequency of discretionary products in the list of items purchased for the account identifier within the period of time deviates one standard deviation from the average frequency of discretionary products in the list of items purchased for all the account identifiers within the period of time.

14. The impulse assessment apparatus of claim 9,
wherein the impulse purchase is a high-frequency for discretionary merchants impulse;
wherein the high-frequency for discretionary merchants impulse is detected for each account identifier by:
determining, with the processor, a frequency of purchases at discretionary merchants for the account identifier within a period of time;
determining, with the processor, an average frequency of purchases at discretionary merchants for all the account identifiers within the period of time;
determining, with the processor, the high-frequency for discretionary merchants impulse exists when the frequency of purchases at discretionary merchants for the account identifier within the period of time deviates one standard deviation from the average frequency of purchases at discretionary merchants for all the account identifiers within the period of time.

15. The impulse assessment apparatus of claim 9,
wherein the impulse purchase is an irregular shopping schedule impulse;
wherein the irregular shopping schedule impulse is detected for each account identifier by:
determining, with the processor, a frequency of purchases at a merchant for the account identifier within a year;
determining, with the processor, a frequency of purchases at a merchant for the account identifier within a month;
determining, with the processor, the irregular shopping schedule impulse exists when the frequency of purchases at a merchant for the account identifier within the month deviates one standard deviation from the average frequency of purchases at a merchant for the account identifier within the year.

16. The impulse assessment apparatus of claim 9,
wherein the impulse purchase is a return and re-purchase impulse;
wherein the return and re-purchase impulse is detected for each account identifier by:
determining, with the processor, a frequency of return and repurchases for the account identifier within a period of time;
determining, with the processor, an average frequency of return and repurchases for all account identifiers within the period of time;
determining, with the processor, the return and re-purchase impulse exists when the frequency of return and repurchases for the account identifier deviates one standard deviation from the average frequency of return and repurchases for all account identifiers.

17. An impulse assessment apparatus comprising:
means for receiving transaction data regarding a plurality of transactions associated with an individual, for each of the plurality of transactions the transaction data comprising: a transaction identifier, an account identifier, a time and date of the transaction, a merchant identifier, and a transaction amount;
means for matching each of the plurality of transactions to a list of items purchased in each transaction in a purchase database, the matching performed using at least one of the transaction identifier, the account identifier, the time and date of the transaction, the merchant identifier, and the transaction amount;
means for detecting an impulse purchase based on the account identifier, the time and date of the transaction, the merchant identifier, the transaction amount and list of items purchased, resulting in a detected impulse purchase;
means for summarizing the detected impulse purchase using independent variables resulting in summarized detected impulse purchases, the independent variables including: time duration, frequency, channel, and the transaction amount;
means for modeling the summarized detected impulse purchases to create an individual impulse prediction model and to generate an individual impulse assessment associated with the account identifier using the individual impulse prediction model;
means for storing the individual impulse prediction model and the individual impulse assessment;
means for transmitting the individual impulse assessment to a merchant, issuer, or acquirer.

18. The impulse assessment apparatus of claim 17, further comprising:
means for machine learning data mining the summarized detected impulse purchases with the independent variables and feedback from the individual impulse prediction model; and
means for modeling the machine learning data mined summarized detected impulse purchases to refine the individual impulse prediction model.

19. The impulse assessment apparatus of claim 17,
wherein the impulse purchase is a one-brand impulse;
wherein the one-brand impulse is detected for each account identifier by:
means for determining a brand of each of the items in the list of items purchased;
means for determining a number of purchases of the brand for each account identifier within a period of time;
means for determining a number of purchases of the brand by an average account identifier within the period of time;
means for determining the one-brand impulse exists when the number of purchases of the brand for the account identifier exceeds one standard deviation from the number of purchases of the brand by an average account identifier.

20. The impulse assessment apparatus of claim 17,
wherein the impulse purchase is a price-oriented impulse;
wherein the price-oriented impulse is detected for each account identifier by:
means for determining an average price of each of the items in the list of items purchased for each account identifier within a period of time;
means for determining an average price of each of the items in the list of items purchased for all account identifiers within the period of time;
means for determining the price-oriented impulse exists when the average price of each of the items in the list of items purchased for the account identifier deviates one standard deviation from the average price of each of the items in the list of items purchased for all account identifiers.

21. The impulse assessment apparatus of claim 17,
wherein the impulse purchase is a high-frequency for discretionary products impulse;
wherein the high-frequency for discretionary products impulse is detected for each account identifier by:
means for determining a frequency of discretionary products in the list of items purchased for the account identifier within a period of time;
means for determining an average frequency of discretionary products in the list of items purchased for all the account identifiers within the period of time;
means for determining the high-frequency for discretionary products impulse exists when the frequency of discretionary products in the list of items purchased for the account identifier within the period of time deviates one standard deviation from the average frequency of discretionary products in the list of items purchased for all the account identifiers within the period of time.

22. The impulse assessment apparatus of claim 17,
wherein the impulse purchase is a high-frequency for discretionary merchants impulse;
wherein the high-frequency for discretionary merchants impulse is detected for each account identifier by:
means for determining a frequency of purchases at discretionary merchants for the account identifier within a period of time;
means for determining an average frequency of purchases at discretionary merchants for all the account identifiers within the period of time;
means for determining the high-frequency for discretionary merchants impulse exists when the frequency of purchases at discretionary merchants for the account identifier within the period of time deviates one standard deviation from the average frequency of purchases at discretionary merchants for all the account identifiers within the period of time.

23. The impulse assessment apparatus of claim 17,
wherein the impulse purchase is an irregular shopping schedule impulse;
wherein the irregular shopping schedule impulse is detected for each account identifier by:
means for determining a frequency of purchases at a merchant for the account identifier within a year;
means for determining a frequency of purchases at a merchant for the account identifier within a month;
means for determining the irregular shopping schedule impulse exists when the frequency of purchases at a merchant for the account identifier within the month deviates one standard deviation from the average frequency of purchases at a merchant for the account identifier within the year.
